(19) United States
(12) Patent Application Publication
(10) Pub. No.: US 2017/0313890 A1
(43) Pub. Date: Nov. 2, 2017

(54) Slurry For Prevention Of Sewer Corrosion

(71) Applicant: Choonghee Rhee, Rancho Palos Verdes, CA (US)

(72) Inventor: Choonghee Rhee, Rancho Palos Verdes, CA (US)

(21) Appl. No.: 15/143,146

(22) Filed: Apr. 29, 2016

(51) Int. Cl. C09D 5/08

(52) U.S. Cl. CPC C09D 5/084

(57) ABSTRACT

An improved sprayable aqueous slurry for inhibiting corrosion in sewer pipelines comprising an aqueous mixture of about 100% by volume of a metal hydroxide and/or a metal dioxide selected from a class consisting of magnesium hydroxide and titanium dioxide and less than about 1% by volume of potassium hydroxide alone or 50 to 50 mixture of potassium hydroxide and sodium hydroxide, the metal hydroxide and the metal dioxide having mixing rates of about 50 to 60% by volume with about 50 to 40% by volume of water and the slurry having a pH of 13.0 or greater and a useful life of about 45 to about 60 months.

### BACKGROUND OF THE INVENTION

U.S. Pat. Nos. 5,620,744, 5,683,748, 5,718,944, 5,834,075 and 6,056,997, hereby incorporated herein by reference, outline the basic causes of corrosion in sewer pipes, such as concrete, iron or steel, as well as the prior attempts to inhibit such corrosion and to reduce the damage and ultimate failure collapse and failure of sewer pipes.

This problem has been known for decades and still remains a problem to this day.

Proposed solutions have ranged from (1) crown spraying or otherwise coating of the inner surfaces of sewer pipes with lime and/or caustic soda slurries as described in the U.S. Pat. Nos. 5,620,744 and 5,683,748 where the purpose of the crown spray process is to leave residual alkalinity on the sewer crown, to (2) the currently exclusively used slurries of 50 to 60% by volume of magnesium hydroxide [Mg(OH)₂] alone in 40 to 50% water mixture as described in the U.S. Pat. Nos. 5,718,944, 5,834,075 and 6,056,997. Unfortunately, sewer pipes continue to corrode and fail, i.e., the current chemical lasts only 7 to 9 months.

The cause of the problem is well understood. As shown in the following FIG. 1, sulfate ions occur naturally in most water supplies and are present in sewage as well, sulfur being required for the synthesis of proteins and being released during their degradation. In a moist atmosphere, such as the anaerobic atmosphere found in sewer pipes, those sulfate ions are chemically reduced to hydrogen sulfide (H₂S) and biologically oxidized by bacteria called thiobacillus or acidithiobacillus to sulfuric acid (H₂SO₄), which is highly corrosive to sewer pipes made of materials soluble to sulfuric acid, such as concrete, iron or steel.

Applicant's solution to the problem of sewer pipe corrosion is quite simple. When applied to the current methods of coating the interiors of sewer pipes using the well-known crown spay procedure it simply involves the addition of less than 1% by volume of potassium hydroxide [KOH] or less than 1% by volume of 50% to 50% mixture of potassium hydroxide [KOH] and sodium hydroxide [NaOH] to the currently applied slurry of 50 to 60% by volume of magnesium hydroxide alone. The result is an immediate increase of the pH of the slurry from about 8.5 to 9.0 to a pH of 13 or greater accompanied by an increased useful life of the slurry from its current 7 to 9 months to 16 to 18 months, which is an improvement of over 100%.

Similar improvements are associated with other of Applicant's proposed solutions as described in detail hereinafter, namely slurry of 50 to 60% by volume of titanium dioxide (TiO₂) and less than 1% by volume of potassium hydroxide or less than 1% by volume of 50% to 50% mixture of potassium hydroxide and sodium hydroxide (NaOH), and mixed slurries of magnesium hydroxide, titanium dioxide and less than 1% by volume of potassium hydroxide alone or less than 1% by volume of 50% to 50% mixture of potassium hydroxide and sodium hydroxide (NaOH) were the useful lives of 50 to 60 months and 45 to 55 months, respectively, which are improvements of over 500% and over 400% when compared to the currently used slurry of magnesium hydroxide alone.

### SUMMARY OF THE INVENTION

An improved sprayable aqueous slurry for inhibiting corrosion in sewer pipelines, comprising an aqueous mixture of about 100% by volume of a metal hydroxide and/or a metal dioxide selected from a class consisting of magnesium hydroxide, titanium dioxide, less than about 1% by volume of potassium hydroxide alone or a mixture of potassium hydroxide and sodium hydroxide were sprayed on the internal surface of sewer pipes, and the metal dioxide, titanium dioxide, having mixing rates of about 50 to about 60% by volume with about 50 to 40% by volume of water and the potassium hydroxide alone or the 50 to 50 mixture of potassium hydroxide and sodium hydroxide having a mixing rate of about less than 1% by volume of slurries and the slurry having a pH of 13.0 or greater and a useful life of about 45 to about 60 months. Name of chemicals and their mixing rates are shown in “Note” of FIG. 3.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a drawing depicting sewer corrosion due to hydrogen sulfide (H₂S) oxidation.

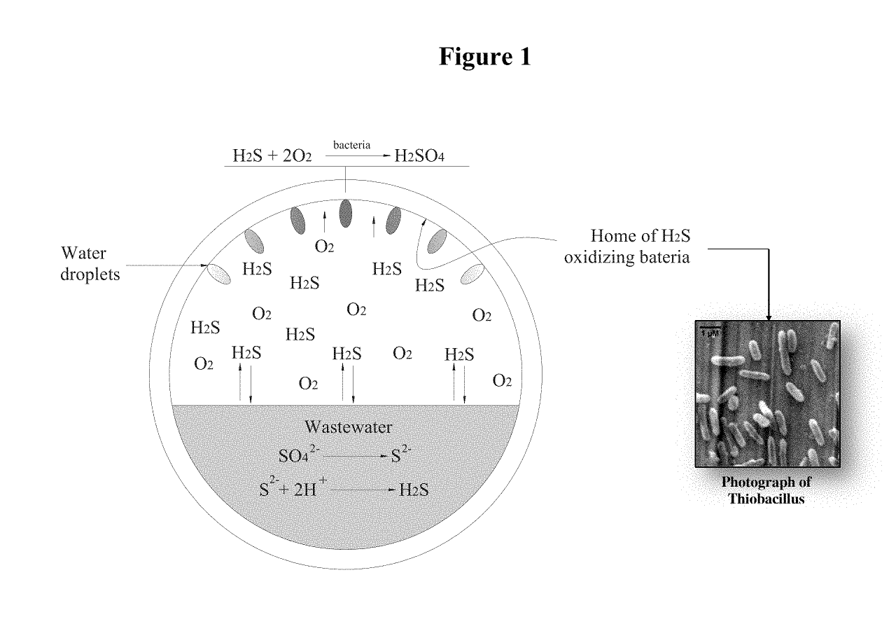

FIG. 2 is diagram depicting the crown spry process for inhibiting sewer corrosion wherein the basic spraying system consists of a spray head mounted on a float that is pulled through the sewer at a controlled rate to spray the crown of the sewer pipe at a predetermined application rate, the spray head receiving its chemicals via a hose extending from a chemical feed tank located above ground at an upstream or insertion manhole and a chemical feed pump delivering the chemicals from the feed tank through a hose to the spray head, the hose being inserted into the sewer as the float is pulled downstream via a cable winch located at the downstream manhole.

FIG. 3 is a table comparing the characteristics of the use of the current slurry of magnesium hydroxide alone to the four new slurries of the present invention namely (1) a three component mixture of “A”, magnesium hydroxide [Mg(OH)₂] and “B”, titanium dioxide [TiO₂], plus “P”, potassium hydroxide [K(OH)], (2) “B”, titanium dioxide [TiO₂], plus “P”, potassium hydroxide [K(OH)], (3) a four component mixture of “A”, magnesium hydroxide [Mg(OH)₂] and “B”, titanium dioxide [TiO₂], plus “P”, potassium hydroxide [K(OH)], plus “S”, sodium hydroxide [Na(OH)], (4) “B”, titanium dioxide [TiO₂], plus “P”, potassium hydroxide [K(OH)], plus “S”, sodium hydroxide [Na(OH)].

FIG. 4 is a chart indicating the variation of pH for the three component mixture of FIG. 3 comprising “A”, magnesium hydroxide, “B”, titanium dioxide plus “P”, potassium hydroxide, in three different experiments.

FIG. 5 is a graph of the variation of pH due to the volume addition of “P”, potassium hydroxide, shown in the FIG. 3, comprising “A”, magnesium hydroxide, and “B”, titanium dioxide and “P”, potassium hydroxide.

FIG. 6 is a chart indicating the variation of pH for the two component mixture of FIG. 3 comprising “B”, titanium dioxide, plus “P”, potassium hydroxide, in three different experiments.

FIG. 7 is a graph of the variation of pH due to the volume addition of “P”, potassium hydroxide in the FIG. 3 comprising “B”, titanium dioxide, plus “P”, potassium hydroxide.

FIG. 8 is a chart indicating the variation of pH for the component mixture of FIG. 3 comprising “A”, magnesium hydroxide, “B”, titanium dioxide plus “P”, potassium hydroxide, and “S”, sodium hydroxide, in three different experiments.

FIG. 9 is a graph of the variation of pH due to the volume addition of the component mixture of “A”, magnesium hydroxide, and “B”, titanium dioxide plus “P” potassium hydroxide and “S”, sodium hydroxide in the FIG. 3.

FIG. 10 is a chart indicating the variation of pH for the component mixture of FIG. 3 comprising “B”, titanium dioxide plus “P”, potassium hydroxide, and “S”, sodium hydroxide, in three different experiments.

FIG. 11 is a graph of the variation of pH due to the volume addition of the component mixture of “B”, titanium dioxide plus “P” potassium hydroxide and “S”, sodium hydroxide in the FIG. 3.

FIG. 12 is a chart of the acid intrusion level and life expectancy at coating thicknesses of 2 millimeters for each of the slurries indicated in the chart of FIG. 3.

FIG. 13 is a chart showing of the variation in the life expectancy (i.e useful life) of each of the slurries indicated in the chart of FIG. 3.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

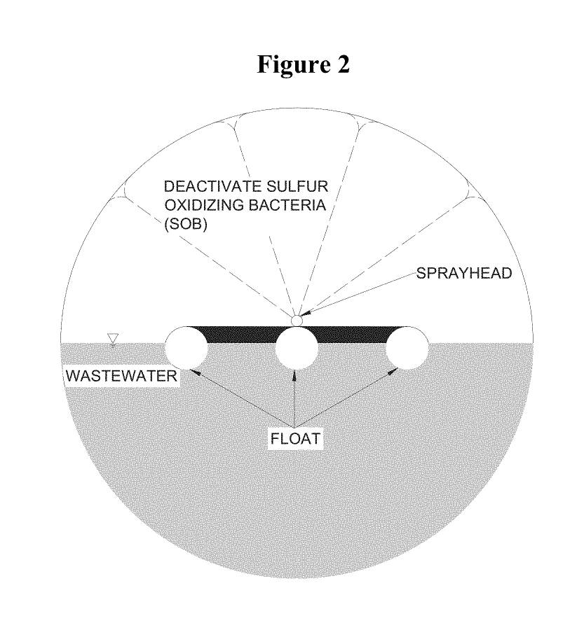

As previously indicated, magnesium hydroxide [Mg(OH)₂] alone, using the “Crown Spray Process” as illustrated in FIG. 2, is the currently applied technology for coating of magnesium hydroxide alone on the internal surface of the sewer pipe to prevent sewer pipe corrosion. Unfortunately, that process and technology results in (i) sewer pipe applied slurries comprising about 50 to 60% magnesium hydroxide alone in 40 to 50% water by volume and (ii) a sewer pipe coating having an initial pH of between 8.5 and 9.0 (averaged to 8.8) and a useful life of less than 7 to 9 months.

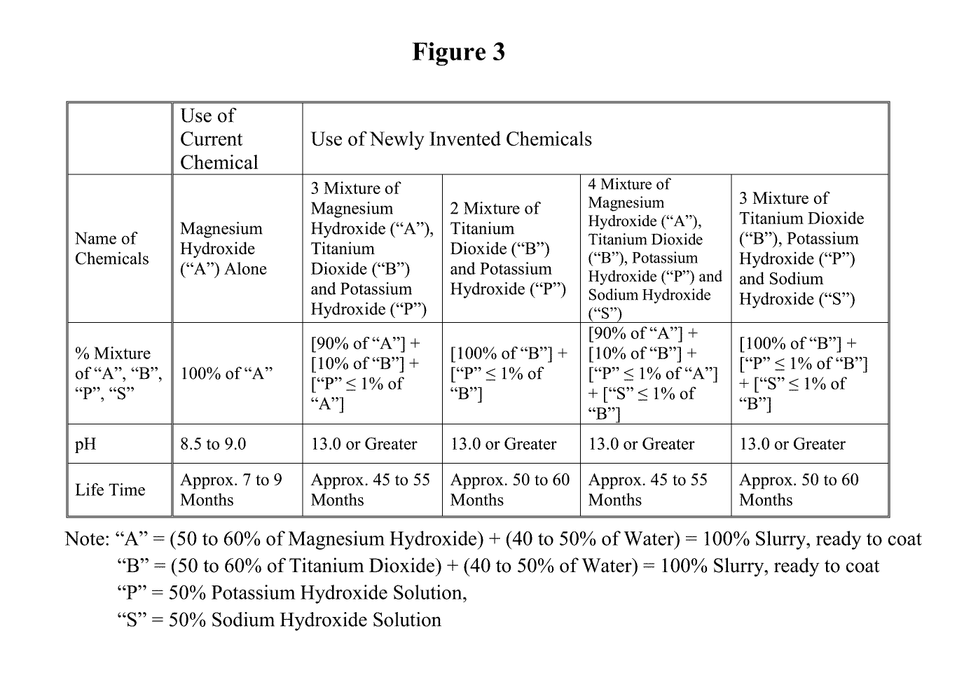

According to experiments conducted during the development of the present invention, and as recorded in the second column (use of current chemical) of FIG. 3 in three different experiments of pH measurements with 100 mL of a 50 to 60% of [Mg(OH)₂] by volume, i.e. in a 40 to 50% water mix, the pH of the 100% magnesium hydroxide mixture is 8.5 to 9.0, averaged 8.8.

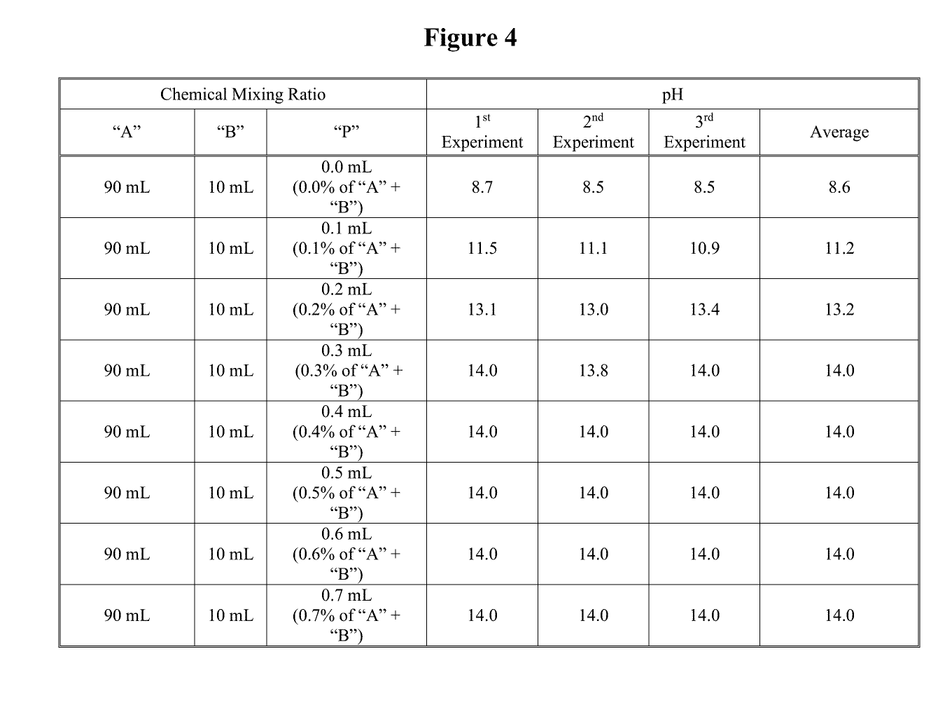

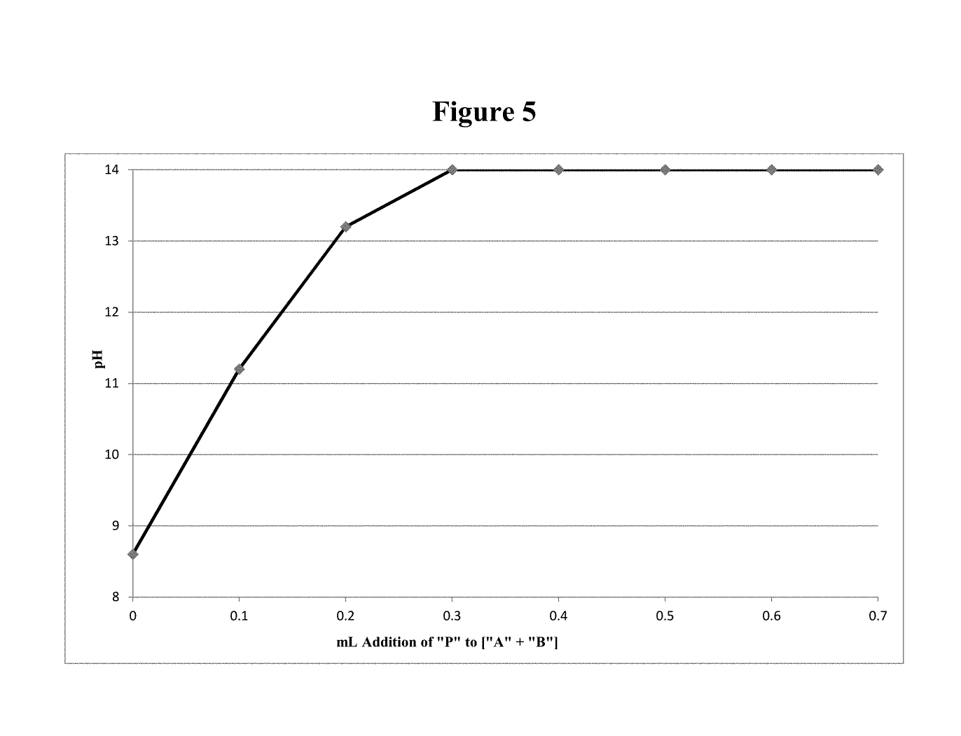

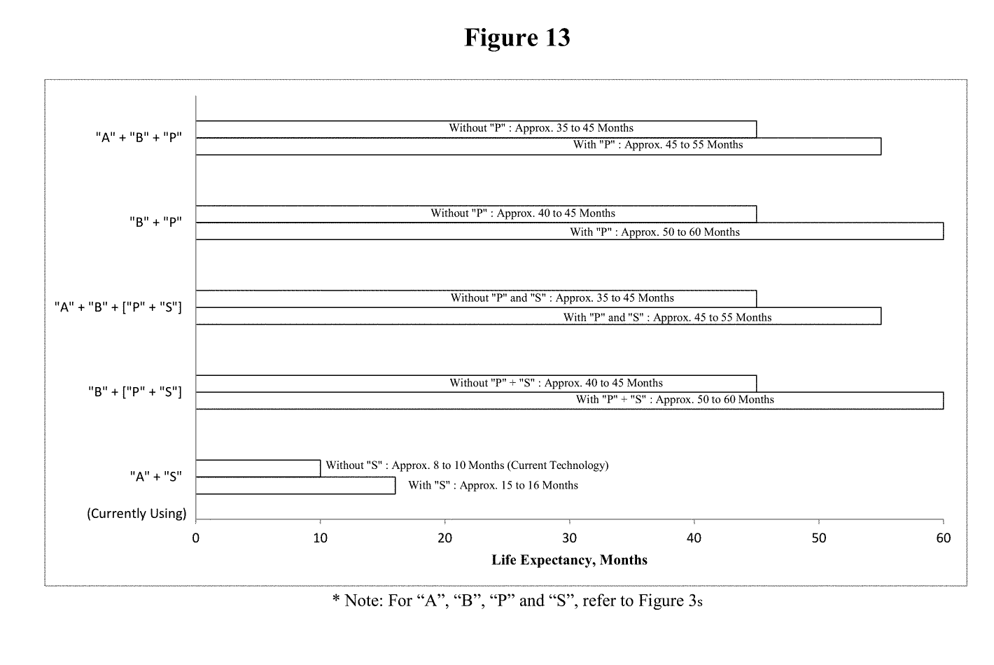

Pursuant to the present invention and as recorded in lines 1 through 8 and columns 4-7 of the table of FIG. 4 and as shown in graph of FIG. 5, upon the addition of small amounts of less than 1%, by volume with water, of potassium hydroxide to 90 mL magnesium hydroxide mixtures and 10 mL titanium dioxide mixtures, the pH of the resulting mixtures increased to 14 while according to FIG. 13, the useful life of the resulting mixtures increased to about 45 to 55 months which represents an increased useful life of about 400% over the useful life for the current magnesium hydroxide slurries alone.

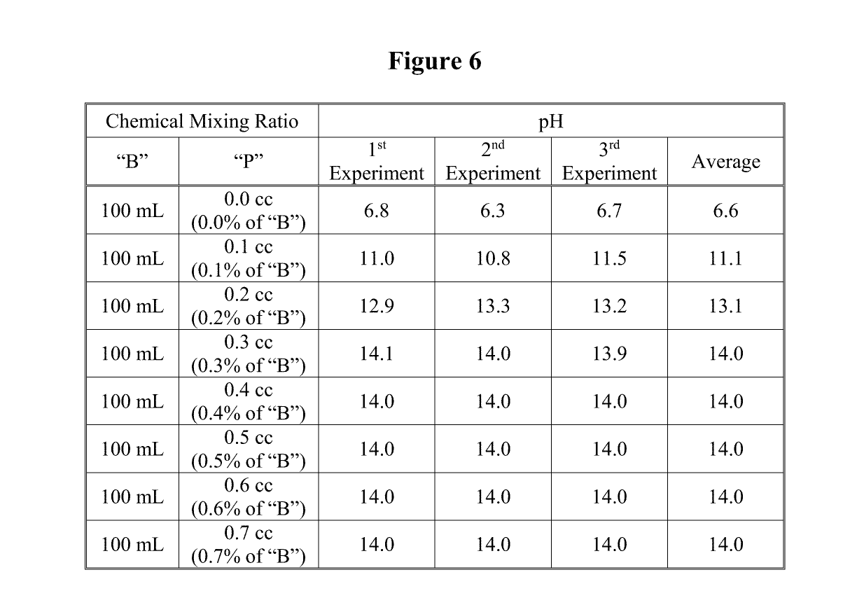

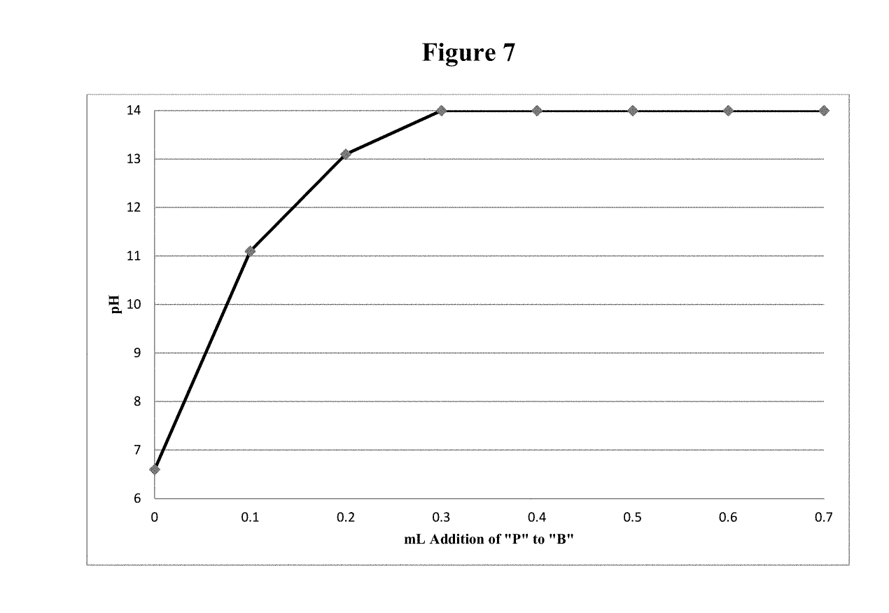

Pursuant to the present invention and as recorded in lines 1 through 8 and columns 3-6 of the table of FIG. 6 and as shown in graph of FIG. 7, upon the addition of small amounts of less than 1%, by volume with water, of potassium hydroxide to 100 mL of titanium dioxide mixtures, the pH of the resulting mixtures increased to 14 while according to FIG. 13, the useful life of the resulting mixtures increased to about 50 to 60 months which represents an increased useful life of about 500% over the useful life for the current magnesium hydroxide slurries alone.

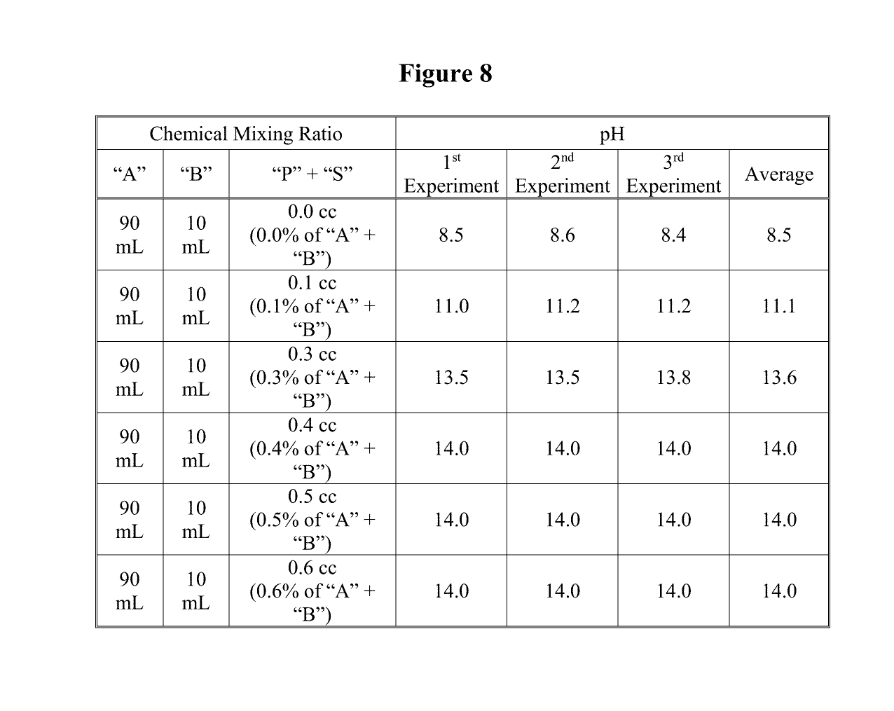

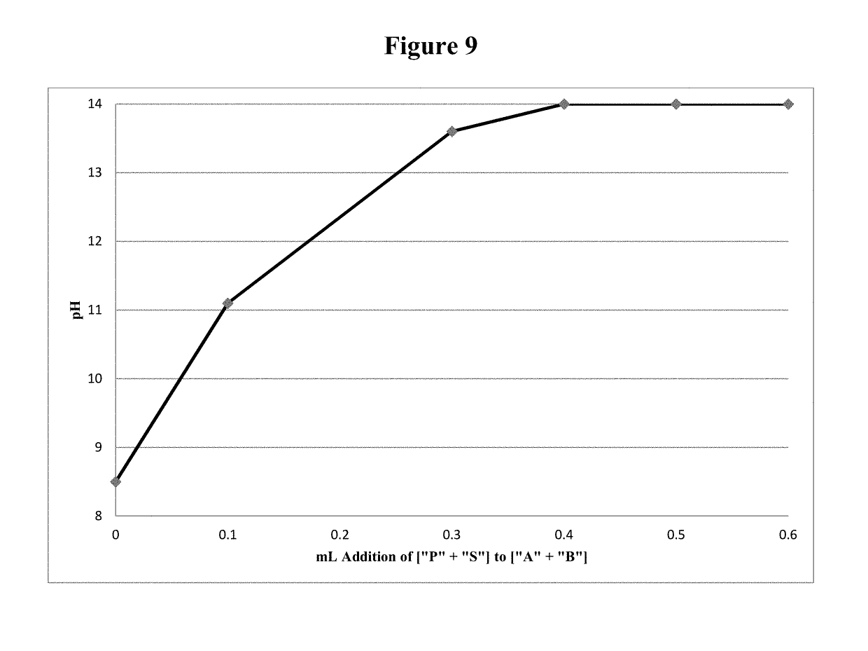

Similarly, pursuant to the present invention and as recorded in lines 1 through 6 and columns 4-7 of the table of FIG. 8 and a shown in graph of FIG. 9, upon the addition of small amounts of less than 1%, by volume with water, of potassium hydroxide and sodium hydroxide mixture (50 to 50) to 90 mL magnesium hydroxide mixtures and 10 mL titanium dioxide mixtures, the pH of the resulting mixtures increased to 14 while according to FIG. 13, the useful life of the resulting mixtures increased to about 45 to 55 months which represents an increased useful life of about 400% over the useful life for the current magnesium hydroxide slurries alone.

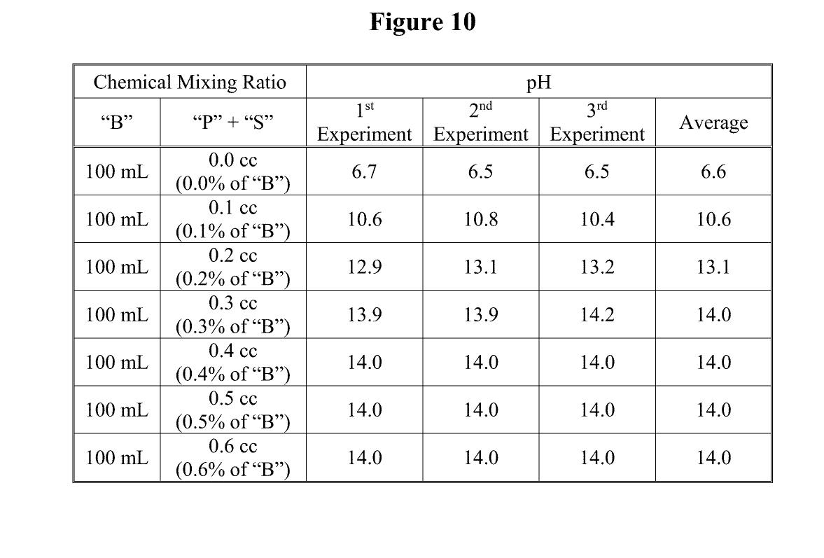

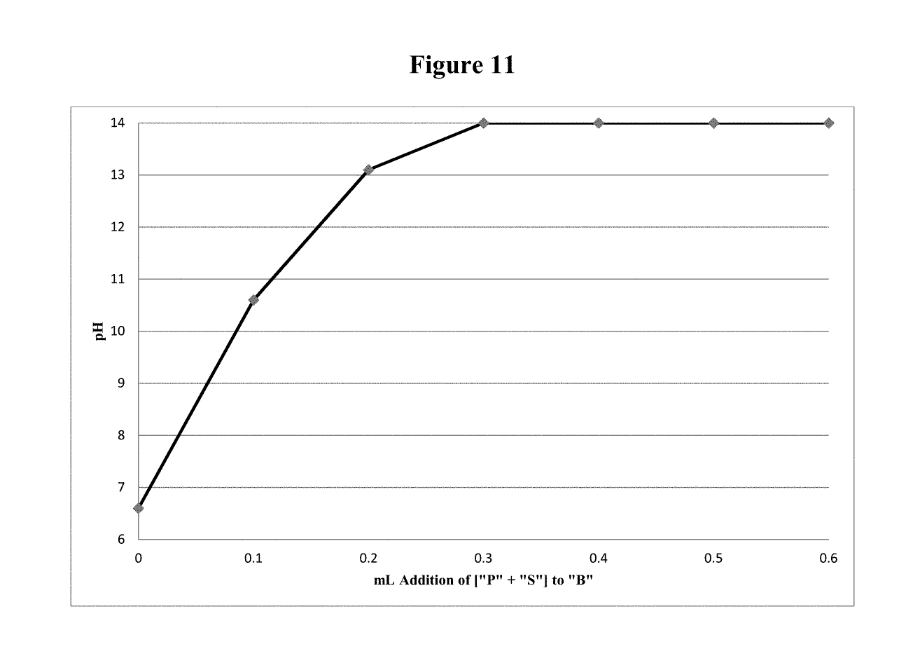

Pursuant to the present invention and as recorded in lines 1 through 7 and columns 3-6 of the table of FIG. 10 and a shown in graph of FIG. 11, upon the addition of negligibly small amounts of less than 1%, by volume with water, of potassium hydroxide and sodium hydroxide mixture (50 to 50) to 100 mL titanium dioxide mixtures, the pH of the resulting mixtures increased to 14.0 while according to FIG. 13, the useful life of the resulting mixtures increased to about 50 to 60 months which represents an increased useful life of about 500% over the useful life for the current magnesium hydroxide slurries alone.

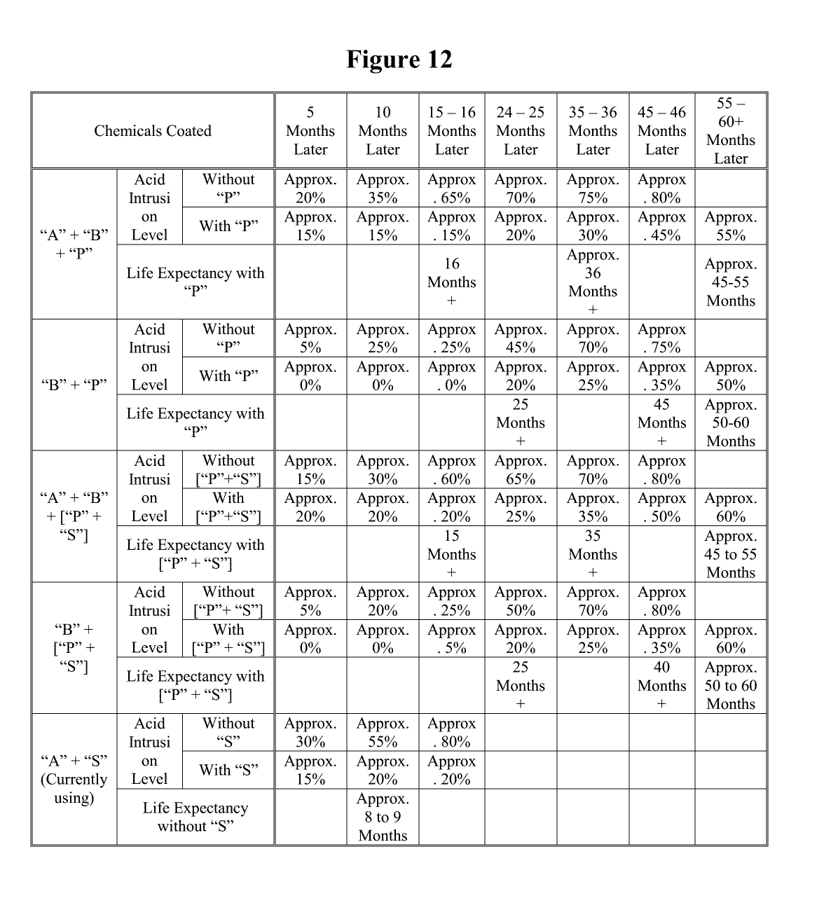

Turning now to FIGS. 12 and 13. First, the chart of FIG. 12 indicates the results of a study of acid intrusion levels into and life expectancy (useful life) of slurries according to each of the four described embodiments of the present invention deposited to a thickness of about 0.08 to about 0.24 inches (2 mm to 6 mm) on the crown of sewer pipes with and without the additions of less than 1% by volume of potassium hydroxide and/or sodium hydroxide as described previously herein over periods of time between 5 months and 55-60 months. Second, the chart of FIG. 13 indicates graphically the life expectancy (useful life) of each of the four described embodiments of the present invention deposited to a thickness of about 0.08 to about 0.24 inches (2 mm to 6 mm) on the crown of sewer pipes with and without the additions of less than 1% by volume of potassium hydroxide and/or sodium hydroxide as described previously herein over periods of time between 5 months and 55-60 months. The last lines of FIGS. 12 and 13 are current uses of magnesium hydroxide slurry alone to compare with the newly invented four embodiments.

From the forgoing, it should be clear that there will be a huge useful life benefit associated with the use of the present invention as a replacement for the current use of slurries of magnesium hydroxide alone. Beyond that, the financial benefits associated with such a replacement will be astronomical.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. An improved aqueous slurry for application to an interior of a sewer pipe to inhibit corrosion thereof, comprising:
a first slurry component comprising one or more of magnesium hydroxide and titanium dioxide;
a second slurry component being less than 1% by volume of said first slurry component; said second slurry component comprising potassium hydroxide or a 50% to 50% mixture of potassium hydroxide and sodium hydroxide; and,
said first slurry component and said second slurry component having mixing rates of about 50% to 60% by volume with about 50% to 40% by volume of water;
wherein the slurry provides a lifespan of about 45 to about 60 months when applied to a thickness of about 0.08 to about 0.24 inch to the interior of the sewer pipe.

2. The improved aqueous slurry of claim 1 wherein the first slurry component is comprised of about 90% by volume of the magnesium hydroxide, about 10% by volume of titanium dioxide.

3. The improved aqueous slurry of claim 1 wherein the first slurry component is comprised of titanium dioxide.

4. The improved slurry of claim 1 wherein said first slurry component is comprised of about 90% by volume of magnesium hydroxide, about 10% by volume of titanium dioxide; and said second slurry component is comprised of a 50 to 50 mixture of potassium hydroxide and sodium hydroxide.

5. The improved slurry of claim 1 wherein the first slurry component is comprised of titanium dioxide and said second slurry component is comprised of a 50 to 50 mixture of potassium hydroxide and sodium hydroxide.

6. An aqueous slurry applied to an interior of a sewer pipe, the aqueous slurry comprising;
1) magnesium hydroxide and/or titanium dioxide, the magnesium hydroxide and/or titanium dioxide having mixing rates of about 50 to 60% by volume with about 50 to 40% by volume of water; and,
2) potassium hydroxide or a mixture of potassium hydroxide and sodium hydroxide, and being in an amount that is less than about 1% by volume of the magnesium hydroxide and the titanium dioxide and the potassium hydroxide and the sodium hydroxide having a mixing rate of about 50% by volume with about 50% of water;
wherein the slurry provides a lifespan of about 45 to about 60 months when it is applied to a thickness of about 0.08 to about 0.24 inch to the interior of sewer pipes.

7. An improvement to an aqueous mixture used to coat an interior of sewer pipes to inhibit corrosion and which comprises magnesium hydroxide, the improved aqueous mixture further comprising:
a first component comprising one or more of magnesium hydroxide and titanium dioxide; and,
a second component of potassium hydroxide or a 50% to 50% mixture of potassium hydroxide and sodium hydroxide, each being less than 1% by volume of the first component;
wherein the improved aqueous mixture provides a lifespan of about 45 to about 60 months when coated as a slurry to a thickness of about 0.08 to about 0.24 inch to the interior of sewer pipes.
